(19) United States
(12) Patent Application Publication
(10) Pub. No.: US 2022/0054959 A1
(43) Pub. Date: Feb. 24, 2022

(54) METHOD AND DEVICE FOR DETERMINING AT LEAST ONE OPERATING PARAMETER OF A FILTER OR A FILTER CARTRIDGE ARRANGED IN THE FILTER, AND FILTER CARTRIDGE

(71) Applicant: HENGST SE, Münster (DE)

(72) Inventors: Sieghard PIETSCHNER, GREVEN (DE); Stephan AHLBORN, SENDEN (DE); Roland EDLERHERR, MENDEN (DE)

(21) Appl. No.: 17/312,833

(22) PCT Filed: Dec. 3, 2019
(86) PCT No.: PCT/EP2019/025427

§ 371 Date: Jun. 10, 2021

(30) Foreign Application Priority Data
Dec. 12, 2018 (DE) 10 2018 131 950.9

(51) Int. Cl. B01D 29/58; B01D 29/60; B01D 35/143; B01D 35/153; B01D 35/16; B01D 36/00

(52) U.S. Cl. CPC B01D 29/58; B01D 29/60; B01D 35/1435; B01D 35/153; B01D 2201/56; B01D 36/005; B01D 36/006; B01D 2201/291; B01D 2201/52; B01D 35/16

(57) ABSTRACT

A method to determine at least one filter operating parameter. At least one transponder arranged on or in a filter cartridge of the filter is contactlessly queried by a reading device. A transponder response is analyzed to evaluate the operating parameter. The transponder is subject to influences acting on the filter cartridge. As a result of the influences that the transponder is sensitive to, or sensitivity on transparency or damping properties of a transmission path of electronic signals between the transponder and the reading device, a transponder response behavior is changed to a degree detectable by the reading device or a downstream analysis unit which enables a statement to be made about the operating parameter. A device for determining at least one operating parameter of a filter or a filter cartridge arranged on or in the filter, and a filter cartridge are both provided.

### CROSS-REFERENCES TO RELATED APPLICATIONS

This application claims the benefit of the International Application No. PCT/EP2019/025427, filed on Dec. 3, 2019, and of the German patent application No. 102018131950.9 filed on Dec. 12, 2018, the entire disclosures of which are incorporated herein by way of reference.

### FIELD OF THE INVENTION

The present invention relates to a method for determining at least one operating parameter of a filter or of a filter cartridge situated in the filter, at least one transponder situated on or in the filter cartridge or in a filter housing of the filter being queried in a contactless manner by a reading device, and the response of the transponder being analyzed in order to evaluate at least one operating parameter of the filter or filter cartridge.

Moreover, the present invention relates to a device for determining at least one operating parameter of a filter or of a filter cartridge situated in the filter, at least one transponder being situated on or in the filter cartridge or in a filter housing of the filter that is capable of being queried in a contactless manner by a reading device, and having an evaluation unit by which the response of the transponder can be analyzed in order to evaluate the at least one operating parameter of the filter or filter cartridge.

Finally, the present invention relates to a filter cartridge.

### BACKGROUND OF THE INVENTION

From EP 1 246 679 B1, a method is known for monitoring a filter element on an aggregate, in which specifying data of the filter element are stored in and/or on the filter element on a suitable memory module. The memory module is a transponder designed as an inductive identification system that transmits the data to a base station in such a way that, using a suitable reading means, the data can be read into an evaluation unit at specified times or at specified time intervals. The transponder measures the degree of contamination of the filter element via the difference pressure, in such a way that the transponder is situated immediately on the filter element and is charged with pressure from both sides, and measures the pressure difference via an expansion measurement strip. The transponder is made up, for example, of an oscillating circuit having a capacitor, an ohmic resistor, and a coil. The expansion measurement strip is connected via a rectifier diode. According to this prior art, for the measurement of the difference pressure, it is useful to situate a single transponder at the interface between the two pressures. From the transponder, an electrical signal is read out that indicates the change of the expansion measurement strip. Further sensors, such as temperature sensors or moisture sensors, can be connected to the transponder.

In this prior art, it is regarded as disadvantageous that the method, in its basic embodiment, can determine only the difference pressure between the two sides of the filter cartridge, and that a further separate sensor has to be used for each additional operating parameter that is to be acquired. This makes the technical outlay high, and the use of the method results in relatively high costs.

### SUMMARY OF THE INVENTION

Therefore, for the present invention an object arises of creating a method of the type named above that avoids the disadvantages of the cited prior art, and that permits a determination of at least one operating parameter of a filter in particular with a low technical and financial outlay. Moreover, a corresponding device with which the method can be carried out, and a suitable filter cartridge, are to be indicated.

A solution of the first part of this object, relating to the method, is achieved according to the present invention by a method of the type named above that is characterized in that the transponder in the filter is exposed during its operation to the influences acting on the filter cartridge, and that through the action of these influences on the transponder itself, which is sensitive to the influences, or on the conducting or damping properties of a transmission path of electromagnetic signals between the transponder and the reading device, the response behavior of the transponder is modified to a degree that is detectable by the reading device or a downstream evaluation unit and that permits a statement to be made about the at least one operating parameter of the filter or filter cartridge.

Advantageously, the method according to the present invention works without the use of special sensors, such as expansion measurement strips, which reduces the technical outlay for the carrying out of the method, and saves costs. Rather, according to the present invention, the influences occurring in the filter and acting immediately on the at least one transponder and its response behavior when queried by the reading device, are used. Depending on which operating parameter or parameters are to be acquired, the transponder itself can be sensitive to a corresponding influence or influences suitable for obtaining a statement for the relevant operating parameter or parameters. The influences used here may be of different types, e.g., chemical and/or biological and/or physical and/or mechanical influences. Alternatively or in addition, modifications, caused by the influences occurring in the filter, in the conducting or damping properties of a transmission path of electromagnetic signals between the transponder and the reading device that change the response behavior of the transponder can be used to acquire one or more operating parameters of the filter or filter cartridge.

In a further embodiment of the method, it is provided that the response behavior of the transponder is queried by the reading device at specifiable time intervals, and that response signals of the transponder acquired by the reading device are compared with stored setpoint values, and are analyzed for the at least one operating parameter of the filter or filter cartridge and/or for the presence of an original filter cartridge in the filter. In addition to the acquisition of at least one operating parameter, the method here offers the possibility of checking the filter to find out whether or not an original filter cartridge, having a transponder, is installed in the filter.

Such a checking function can be realized, for example, through a design of the transponder in which, after a specified time, under the influence of the filtrate a specified signal damping is introduced. The signal of the transponder is read out after the specified time and is compared to the specified signal damping. A specified time can be, for example, a duration of some days or weeks, but also of only a few minutes. In this way, for example, a transponder can be used that is designed such that within a short time a specified signal damping can be determined in that, e.g., a material that swells under the influence of the filtrate is used on or in the housing or casing of the transponder. In particular given short specified times, the determination of the specified signal damping can also include that the response behavior of the transponder is first acquired already in the not-yet-installed state, by an additional reading device, or, in the case of a mobile reading device, by the same reading device.

The second part of the object, relating to the device, is achieved according to the present invention by a device of the type named above that is characterized in that the transponder, which is exposed to influences acting on the filter cartridge in the filter during the operation thereof, and is sensitive to the influences, is capable of being modified through the action of these influences on the transponder itself or on the conducting or damping properties of a transmission path of electromagnetic signals between the transponder and the reading device with regard to its response behavior, to a degree that is detectable by the reading device or the evaluation unit and that permits a statement to be made concerning the at least one operating parameter of the filter or filter cartridge.

With the device according to the present invention, the method described above can be carried out with a low technical outlay, and the device is also well suited for use in mass-produced articles such as fuel filters of internal combustion engines in motor vehicles or dust filters in vacuum cleaners or industrial filter applications.

In a first embodiment of the device, it is provided that a housing or casing of the transponder in the filter is attackable or destructible by chemical and/or biological and/or physical and/or mechanical attack, and that the transponder as a whole, or at least a component of the transponder, is thereby capable of being damaged or destroyed to an extent such that the response behavior of the transponder capable of being acquired by the reading device can be modified thereby. The modification of the response behavior of the transponder consists, in particular, in a weakening of a response signal, or in a complete absence of the response signal. The degree of modification and the time of the onset of the modification of the response behavior of the transponder are a function of the strength and the duration of the action of the chemical and/or biological and/or physical and/or mechanical attack, and of the specifiable resistance capacity of the material of the housing or casing of the transponder. By matching the properties of the housing or casing of the transponder to the relevant influences, it can be brought about that a modification of the response behavior of the transponder begins, for example, when the filter cartridge is worn out and needs to be exchanged.

Alternatively or in addition thereto, it can be provided that a housing or casing of the transponder in the filter is capable of being modified, by chemical and/or biological and/or physical and/or mechanical action, in its conducting or damping properties for electromagnetic signals transmitted between the transponder and the reading device, and that the response behavior of the transponder, capable of being acquired by the reading device, is modifiable thereby. In this embodiment of the device, in particular a time-dependent reduction or increase in the response signal strength of the transponder, acquired by the reading device, will occur as modification of the response behavior of the transponder. The degree of the modification and the time of the onset of the modification of the response behavior of the transponder are, here as well, a function of the strength and the duration of the action of the chemical and/or biological and/or physical and/or mechanical attack and of the specifiable resistance capacity of the material of the housing or casing of the transponder. By adjusting the properties of the housing or casing of the transponder to the relevant influences, here as well it can be achieved that a modification of the response behavior of the transponder, for example, begins when the filter cartridge is worn out and needs to be exchanged.

A further embodiment of the device proposes that the transponder be situated in a region of the filter occupied in temporal succession by media that differ in their conducting or damping properties for electromagnetic signals transmitted between the transponder and the reading device, and that the response behavior capable of being acquired by the reading device of the transponder be modifiable thereby. The filter can here, for example, be a diesel fuel filter having a water separator and an integrated water collecting area containing the transponder, in which at first diesel fuel is situated that is gradually displaced by deposited water over a certain operating time of the filter. Here, use is made of the different properties of diesel fuel and water with regard to the transmission of electromagnetic signals through these media from the transponder to the reading device.

Depending on the requirements in the particular case of use, one or more transponders may be present in the device that are sensitive to one or more influences.

In this regard, in a first embodiment of the device the transponder is made sensitive to a single determined influence.

In this regard, in a further embodiment of the device the transponder is made sensitive to two or more different influences.

In addition, there is the possibility of making the transponder and/or the housing or casing of the transponder temperature-sensitive in such a way that, through a one-time exceeding of a specifiable boundary temperature to which the transponder and/or the housing or casing of the transponder are/is exposed, the response behavior of the transponder, capable of being acquired by the reading device, is capable of being permanently modified.

It is also possible for the housing or casing of the transponder to have regions made of at least two different materials that are sensitive to different influences.

A further embodiment of the device proposes that the housing or casing of the transponder has at least one region that forms an electrical resistance path whose electrical resistance is measurable by the transponder or by an electronics unit assigned to the transponder, a change in the measured resistance causing a modification of the response behavior of the transponder that is detectable by the reading device or the evaluation unit and that permits a statement to be made about the at least one operating parameter of the filter or filter cartridge.

An embodiment of the device is also conceivable that has two or more transponders, each sensitive to a single specified influence, and/or two or more transponders each sensitive to two or more different influences.

In an advantageous development of the device, it is provided that the device has, in addition to the at least one transponder modifiable in its response behavior, at least one transponder, situated on or in the filter cartridge, that is protected against or is durable against all influences acting during operation of the filter, as a permanently unmodifiable identification bearer and proof of originality of the filter cartridge. In this way, it is ensured that even given a deliberately damaged or destroyed first transponder having a modifiable response behavior, an unambiguous identification of the filter cartridge is still possible by reading out the protected or durable further transponder. Here as well, there is the possibility of evaluating one or more operating parameters of the filter or filter cartridge by comparing the response behavior of the transponder having the modifiable response behavior to the response behavior of the protected or durable transponder.

In a further embodiment, it is provided that in all transponders allocated to a filter or filter cartridge, identification codes that correspond to one another and are readable by the reading device are stored. In this way, immediately after exchanging a filter cartridge, i.e., as long as all transponders in the filter cartridge are still not influenced by the action of operational influences, the filter cartridge can be checked for originality. If it is determined that the filter cartridge is not original, then, for example, a corresponding warning message can be issued, or the starting of an associated device having the filter with the filter cartridge, such as an internal combustion engine, can be blocked. In this way, the security of the identification of filter cartridges installed in a filter is improved, and abusive falsification of filter cartridges is made more difficult.

In addition, for the device, the present invention proposes that the transponder or transponders be attached on or in a filter material body of the filter cartridge, or on or in at least one end plate of the filter cartridge, or on or in a wall of the filter housing, in particular, being glued on or glued in, or welded on or welded in, or molded on or molded in. The concrete attaching of the transponder or transponders is done in accordance with the requirements of the individual case of use, and is done in such a way that it permits the evaluation of the desired operating parameter or parameters of the filter or filter cartridge.

In a particularly useful application, the device is part of a fuel filter or motor oil filter or hydraulic oil filter or transmission oil filter or air filter, it being provided that the housing or casing of the transponder modifiable in its response behavior is made up at least in part of a material that is attackable or decomposable, or is modifiable in its conducting or damping properties for electromagnetic signals transmitted between the transponder and the reading device, by fuel or oil or air and/or by one or more substances contained in the fuel or oil or air. In this application, as generally explained above, the need to exchange the filter cartridge can be determined as operating parameter. In addition, a statement can be obtained indicating that particular, in particular undesirable, substances are contained in the fluid flowing through the filter, such as sulfur in the fuel or glycol in the oil. Further examples for the determination of undesirable substances as an operating parameter is the detection of aging products in the fluid, such as increasing acid content in aging oil, or the detection of biodiesel components or undesirable contents such as spirits in the fuel.

In many filter applications, it can happen that a medium to be filtered, such as air or biodiesel, is contaminated with microorganisms and/or water. An embodiment of the device directed to this therefore provides that the housing or casing of the transponder modifiable in its response behavior is made up at least in part of a material that by contact with microorganisms and/or with water is attackable or decomposable or modifiable in its conducting or damping properties for electromagnetic signals transmitted between the transponder and the reading device. In this way, using the device it can be determined whether contamination of the type indicated is present.

A further embodiment of the device provides that the at least one transponder, modifiable in its response behavior, is spatially allocated to a difference pressure valve or difference pressure sensor of the filter or filter cartridge, and that, by means of an element of the difference pressure valve or difference pressure sensor that is movable when a specifiable boundary value is exceeded for a difference pressure between the raw side and clean side of the filter, the transponder can be mechanically damaged or destroyed, or the signal transmission property of the signal transmission path between the transponder and the reading device can be modified, in such a way that the response behavior of the transponder capable of being acquired by the reading device is modifiable thereby. Here there takes place an abrupt modification of the response behavior of the transponder through sudden mechanical action that begins when a difference pressure boundary value is exceeded, caused by contamination of the filter cartridge with filtered-out dirt particles.

In order to avoid premature mechanical damage to or destruction of the transponder, not due to wearing out of the filter cartridge, which could arise, for example, due to cases of exceeding difference pressure boundary values as a result of low temperature of high-viscosity fluids to be filtered, the functioning of the difference pressure valve or the difference pressure sensor can have a temperature dependence; in particular it can be capable of being deactivated at temperatures below a specifiable boundary value.

In order to keep the filter cartridge equipped with one or more transponders, which is a consumable part, low in cost, the transponder/at least one of the transponders is a passive RFID transponder.

Alternatively, the transponder/at least one of the transponders is a semi-active or active RFID transponder having its own electrical energy source. In this embodiment, the transponder can take over additional functions, for example in order to ascertain, with a high degree of accuracy, operating parameters of the filter or filter cartridge that are of interest.

In this regard, a preferred development provides that the/each semi-active or active RFID transponder is set up for an automatic modification of digital response signal information that is to be outputted, the modification taking place as a function of modifications of the at least one operating parameter of the filter or filter cartridge acquired by the transponder or by at least one sensor allocated thereto.

In addition, it is proposed that the/each RFID transponder is situated on a carrier foil that is bonded, preferably glued or welded, to an inner surface of the filter housing or to the filter cartridge. An RFID transponder situated on a carrier foil is thus advantageously easily connectable to the filter housing or filter cartridge.

Finally, for the device according to the present invention it is provided that the reading device is connected fixedly or detachably to the filter, or that the reading device is a separate, handheld mobile device. The evaluation unit mentioned above can be integrated into the reading device, or can also be situated separately from the reading device, and can be connected thereto for data transmission via cable or wirelessly.

In order to achieve the third part of the object, relating to the filter cartridge, the present invention proposes a filter cartridge for use in a filter, the filter cartridge being exchangeable. The filter cartridge is characterized in that it has at least one transponder that, during filter operation, is exposed to the influences acting on the filter cartridge, and that is modifiable in its response behavior by these influences, as part of the device. Such a filter cartridge is designed specifically in order to carry out the method described above and for use in a filter equipped with the device described above.

### BRIEF DESCRIPTION OF THE DRAWINGS

In the following, exemplary embodiments of the present invention are explained on the basis of a drawing.

FIG. 1 shows a device in a schematic representation that is allocated to a filter shown in schematic longitudinal section, in a first embodiment,

FIG. 2 shows the device in a schematic partial representation, allocated to a filter shown in schematic longitudinal section, in a second embodiment, together with an enlarged detail showing a transponder in a schematic view,

FIG. 3 shows the device in a schematic representation, allocated to a filter shown in schematic longitudinal section, in a third embodiment,

FIG. 4 shows a transponder as an individual part of the device, in a schematic plan view,

FIGS. 5 through 8 each show a transponder having different housings or casings, each in a schematic cross-section,

FIG. 9 shows the device in schematic representation, allocated to a filter shown in schematic longitudinal section, in a fourth embodiment,

FIG. 10 shows the device in schematic representation, allocated to a filter shown in schematic longitudinal section, in a fifth embodiment, and

FIG. 11 shows the device in schematic representation, allocated to a filter shown in schematic longitudinal section, in a sixth embodiment.

### DETAILED DESCRIPTION OF THE PREFERRED EMBODIMENTS

In the following description of the Figures, identical parts in the various Figures of the drawing are always provided with the same reference characters, so that all reference characters do not have to be explained again for each Figure.

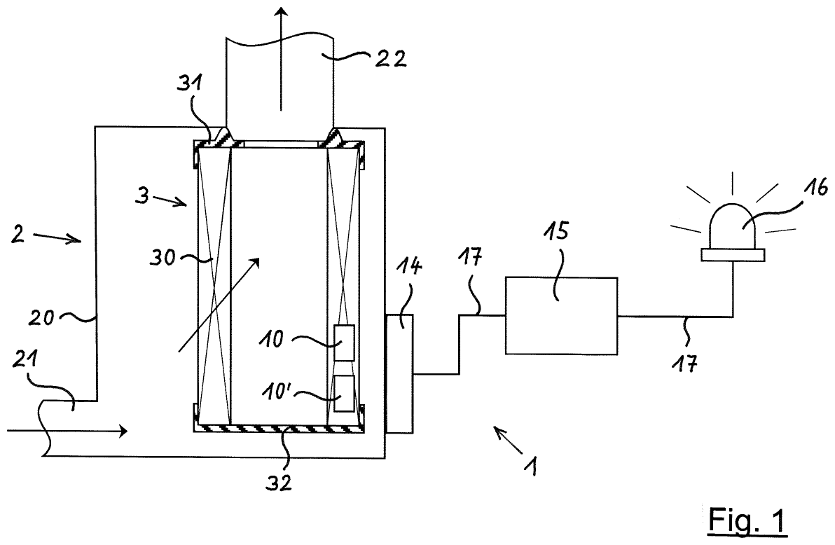

FIG. 1 shows a device 1 in a schematic representation allocated to a filter 2, shown in schematic longitudinal section, having a filter cartridge 3, in a first embodiment.

Filter 2 is of a known design and has a filter housing 20 in which filter cartridge 3 is exchangeably situated. Filter cartridge 3 is made up of a filter material body 30, e.g., a star-shaped folded filter material web, enclosed at its ends by an upper end plate 31 and a lower end plate 32.

Through an inlet 21, during operation of filter 2 a fluid medium to be filtered, e.g., fuel, lubricant oil, or air, flows in the direction of the arrow into the interior of filter housing 20, where it then flows, in the radial direction from the outside to the inside, through filter material body 30 of filter cartridge 3. Here, at first dirt particles carried along in the medium are retained in filter material body 30, whereby the medium is freed of these dirt particles. Through an outlet 22 at the upper side, the now-filtered medium exits filter 2 according to the flow arrow shown there.

In the exemplary embodiment shown in FIG. 1, device 1 has two transponders 10, 10′, realized, for example, as known RFID transponders and attached adjacent to one another on filter material body 30 of filter cartridge 3 of filter 2, for example by gluing or welding.

In addition, device 1 includes a reading device 14 that is situated externally on filter housing 20 of filter 2, and by which transponders 10, 10′ can be addressed and queried. Reading device 14 can be situated permanently on filter housing 20, or alternatively can be a mobile handheld device.

Downstream from reading device 14 there is situated an evaluation unit 15 that is electrically connected to reading device 14 via a connecting line 17 for data transmission. Alternatively, the connection between reading device 14 and evaluation unit 15 can also be a wireless connection.

Via a further segment of connecting line 17, a display unit 16 is also connected to evaluation unit 15, by which display unit here an optical display, alternatively or in addition also an acoustic display, can be outputted.

Transponders 10, 10′ are exposed to the influences acting on filter cartridge 3 in filter 2, during operation thereof, the one transponder 10 being made sensitive to at least one of these influences, in such a way that its response behavior, which can be determined by querying by reading device 14 and evaluation by evaluation unit 15, is itself modified by the action of these influences on transponder 10.

For this purpose, during operation of filter 2 a housing or casing of transponder 10 can be attackable or destructible by chemical and/or biological and/or physical and/or mechanical attack, and in this way transponder 10 as a whole, or at least a component of transponder 10, can be capable of being damaged or destroyed to an extent such that the response behavior of transponder 10, capable of being acquired by reading device 14, is recognizably modified, and that at least one operating parameter of filter 2 or of its filter cartridge 3 is evaluable therefrom.

Alternatively or in addition thereto, during operation of filter 2 the housing or casing of transponder 10 can be capable of being modified by chemical and/or biological and/or physical and/or mechanical action in its conducting or damping properties for electromagnetic signals transmitted between transponder 10 and reading device 14, and the response behavior, capable of being acquired by reading device 14, of transponder 10 can be modifiable thereby, and also from this at least one operating parameter of filter 2 or of its filter cartridge 3 can be evaluated.

In addition to transponder 10, modifiable in its response behavior as a function of the influences acting on it, further transponder 10′ is situated on filter cartridge 3. This further transponder 10′ is a transponder protected against or durable against all influences acting during operation of filter 2, and acts as a permanently unmodifiable identification bearer and proof of originality of filter cartridge 3. For this purpose, further transponder 10′ has, for example, a housing or casing made of a material that is not, or in any case at most is not to any relevant degree, modified or damaged by the influences that act during operation of the associated filter cartridge 3.

Further transponder 10′ can be read out using the same reading device 14 in order to enable determination of the presence of an original filter cartridge 3 in filter 2, without having to remove filter cartridge 3 from filter 2. In addition, further transponder 10′ can be used as a reference for transponder 10 modifiable in its response behavior, in order to evaluate, through comparative analysis, the at least one operating parameter of the filter or filter cartridge.

For example, for this purpose, transponder 10′ can be designed in its response behavior in such a way that the response behavior corresponds to the response behavior of transponder 10 before a modification of its response behavior. Alternatively, transponder 10′ can also, for example, be designed in its response behavior in such a way that it has a particular signal difference from the response behavior of transponder 10 before a modification. It is conceivable that second, further transponder 10′ be provided in the immediate vicinity of first transponder 10; however, it can also be situated at a distance therefrom, if for example transponders 10, 10′ are attached on the two end plates 31, 32. Second transponder 10′ could also be provided in non-exchangeable fashion in filter 2, separate from filter cartridge 3, or could be provided in a packaging of filter cartridge 3.

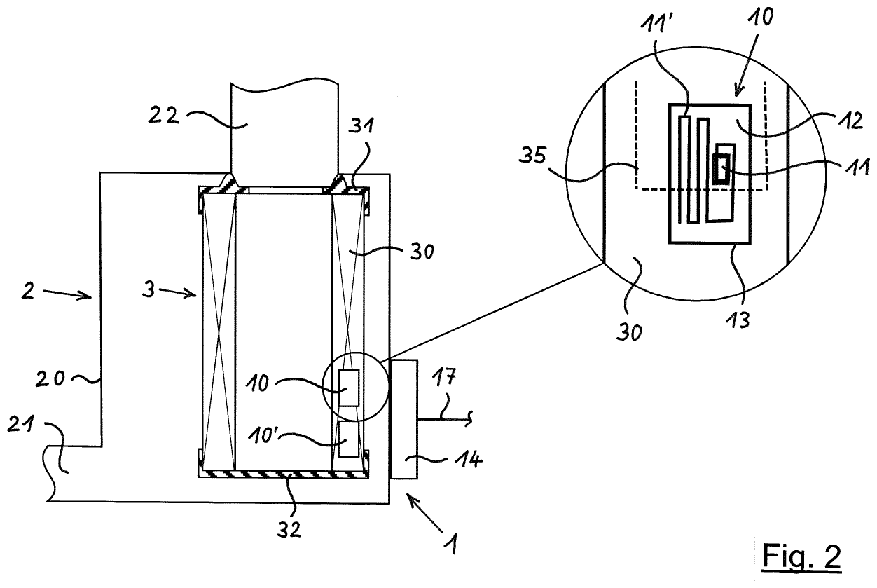

FIG. 2 shows device 1 in a schematic partial representation, assigned to a filter 2 shown in schematic longitudinal section, in a second embodiment, together with an enlarged detail.

Filter 2, to which device 1 according to FIG. 2 is allocated, corresponds to filter 2 shown in FIG. 1.

Different here is the design of filter cartridge 3, which is now equipped with a difference pressure sensor 35. Difference pressure sensor 35 reacts mechanically to the exceeding of a boundary value of a difference pressure between a raw side and a clean side of filter 2 and of filter cartridge 3; in the depicted exemplary embodiment this takes place in that a flap-shaped segment, bounded by a scored line, of filter material body 30 is pressed out from the surface of filter material body 30. Such an exceeding of the boundary value of the difference pressure occurs, in particular, when filter material body 30 of filter cartridge 3 has become contaminated and clogged with dirt particles deposited therein from the medium to be filtered to such an extent that replacement of filter cartridge 3 is appropriate.

At top right in FIG. 2, an enlarged detail is shown that shows a part of filter material body 30 of filter cartridge 3, flap-shaped difference pressure sensor 35, and transponder 10 attached thereon in overlapping fashion. Transponder 10 is here realized as an RFID transponder situated on a carrier foil 12, having a chip and a printed antenna 11′.

Through the flap movement of difference pressure sensor 35, triggered by the exceeding of a specifiable difference pressure boundary value, transponder 10, situated in this region and covering the scored line, is torn into two parts, or is at least significantly deformed and is thereby destroyed or damaged to such an extent that its response, when queried by reading device 14, is significantly modified compared to the original, earlier response, or is even completely absent. Here, as an operating parameter a need to exchange filter cartridge 3 is thus evaluated by device 1, and is indicated by display unit 16 shown in FIG. 1, which also appertains to device 1 according to FIG. 2 and is controlled by evaluation unit 15.

In the example of FIG. 2 as well, in addition to transponder 10 modifiable in its response behavior, further transponder 10′, with the properties and functions explained on the basis of FIG. 1, is also situated on filter cartridge 3.

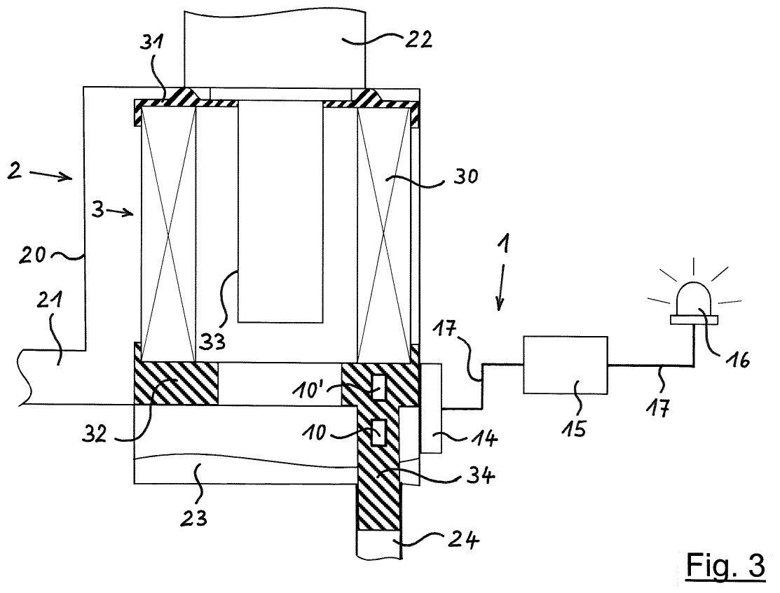

FIG. 3 shows device 1 in a schematic representation, allocated to a filter 2, having filter cartridge 3 shown in schematic longitudinal section, in a third embodiment.

Filter 2, to which device 1 is here allocated, is a fuel filter, specifically a diesel fuel filter, in which, in addition to solid particles, water droplets are also separated from the fuel to be filtered. For this purpose, in addition to filter cartridge 3 for separating the solid particles from the fuel, filter 2 has in its central region, situated inside filter cartridge 3, a water droplet sieve 33, and has in its lower part a water collection region 23. Here, filter material body 30 is usefully made of a material that has a coalescer effect, or is combined with, e.g., filled or surrounded by, such a material.

During operation of this filter 2, water droplets held back from the filtered fuel at water droplet sieve 33 sink downward due to their density, which exceeds the density of the fuel, under the force of gravity, into the water collection region 23, which at first is also filled with fuel. In this way, the fuel situated in water collection region 23 is gradually expelled and replaced by water.

In order to drain the water collected in water collection region 23 as needed, a drain duct 24 goes out from this region, which duct is sealed by a sealing mandrel 34 during operation of filter 2. Sealing mandrel 34 is part of filter cartridge 3, and goes out from a lower end plate 32 of filter cartridge 3.

On an upper region of sealing mandrel 34, situated in water collection region 23, transponder 10, modifiable in its response behavior, is situated as a part of device 1. The response behavior of this transponder 10 is modified in such a way that, in an initial state of filter 2, at first fuel is situated in water collection region 23, and later, after a certain operating time, water is situated there.

Because fuel and water have different conducting or damping properties for electromagnetic signals transmitted between transponder 10 and reading device 14, here using device 1, it is detectable whether a quantity of water has collected in water collection region 23 such that draining of water by opening drain duct 24 is appropriate.

Above transponder 10, modifiable in its response behavior, here again the further transponder 10′, protected or durable against influences acting in filter 2, is situated, concerning whose function and purpose reference is made to the preceding description.

The further elements of device 1 shown in FIG. 3 correspond to the elements described in FIG. 1.

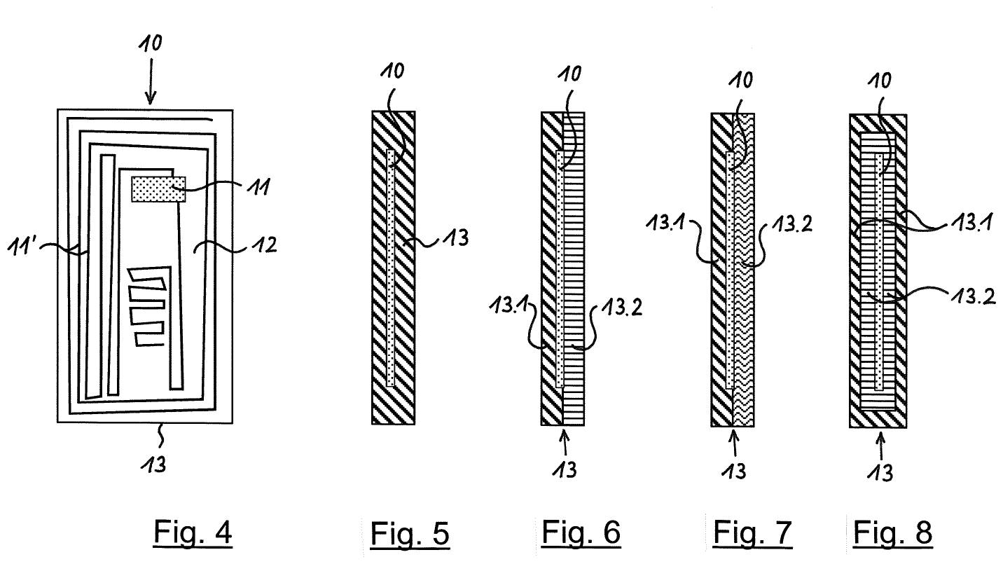

FIG. 4 shows a transponder 10 as individual part of device 1, in a schematic plan view. Transponder 10 is here as well realized as an RFID transponder situated on a carrier foil 12, and has a chip 11 and an antenna 11′ that is electrically connected therewith and is printed on carrier foil 12.

In addition, transponder 10 has a housing or casing 13 that, depending on the case of use of transponder 10, has different properties, as is explained in more detail below with reference to some examples.

FIG. 5 through 8 each show a transponder 10 having different housings or casings 13, in each case in a schematic cross-section.

Casing 13 according to FIG. 5 is made up of a uniform material that completely surrounds and encloses transponder 10 on all sides, the material being sensitive to at least one influence that acts during operation.

In the example according to FIG. 6, casing 13 is formed from two casing regions 13.1, 13.2, each forming half of a casing and made of two different materials, only one of the materials being sensitive to influences acting during operation. The division into two casing halves is here to be understood purely schematically; in principle, any ratio of the casing regions 13.1, 13.2 formed by the different materials may be provided. For example, the material sensitive to influences acting during operation may also comprise only a small area that is, for example, sufficient to permit a lack of tightness of casing 13 after an influence acting over a certain period of time, which then significantly alters the response behavior of the transponder as a result of the entry of filtrate present in the filter, such as fuel, at the transponder.

FIG. 7 shows an example of transponder 10 in which, as in FIG. 6, casing 13 is made up of two casing regions 13.1, 13.2 made of different materials. Differing from the example of FIG. 6, here the two materials are sensitive to different influences.

FIG. 8 shows an example of transponder 10 in which this transponder is surrounded by a two-layer casing 13 having an outer casing region 13.1 and an inner casing region 13.2. The two casing regions 13.1, 13.2 are made of different materials, only the material forming outer casing region 13.1 being sensitive to the action of a particular influence. Inner casing region 13.2 thus always forms a protective layer by which the functioning of transponder 10 is maintained. Outer casing region 13.1 can, for example, be made such that the signal conducting is significantly modified, i.e., increased or lowered, by the action of an influence. For this purpose, outer casing region 13.1 can, for example, also be decomposed; transponder 10 remains protected by inner casing region 13.2.

In order to achieve the desired modifiability of the response behavior of transponder 10, the material of casing 13, and at least parts of transponder 10, have the property of reacting to influences that act during operation in the filter.

This reaction can be, for example, a decomposition or dissolving, extending over a certain time period, of the material of casing 13, and subsequent damage or destruction of transponder 10. Depending on the material used for casing 13, casing 13 can be sensitive to the action of a particular influence, or also to the action of more than one influence, for example, to sulfur contained in the fuel.

Another usable reaction can be a modification, caused by the acting influences, of the conducting or damping properties of the material of casing 13 for electromagnetic signals transmitted between transponder 10 and reading device 14.

Various materials, in particular plastics, are possible as materials for the housing or casing 13 of transponders 10, which materials, for example, dissolve and/or swell and/or become brittle in particular media that are to be filtered in the filter. Some examples are named below.

Polyvinyl alcohol (PVAL) as housing or casing material is etchable or dissolvable under the action of water or moisture.

Polyvinyl acetate (PVAC) as housing or casing material is etchable or dissolvable in lower alcohols, ketones, esters (biodiesel), cyclical ethers, aromatic and chlorinated hydrocarbons.

Acryl nitrile butadiene rubber (NBR) as housing or casing material reacts specifically to biodiesel. In particular, depending on the composition of the plastic, swelling occurs. For example, the acryl nitrile portion (approx. 15-60%) defines the swelling behavior, and in biodiesel fuel this material can swell by a factor of 2-4 more than in mineral diesel fuel. Different swelling behavior of biodiesel fuel types, e.g., rapeseed methyl ester compared to soy methyl ester having a high portion of unsaturated fatty acid esters, can result in significantly different detectable swelling behavior, because this material expands more strongly under the action of soy methyl ester.

Chloroprene rubber (CR), chlorosulfonated polyethylene rubber (CSM), ethylene propylene diene rubber (EPDM), and butyl rubber (IIR) are further housing or casing materials having increased swelling behavior in biodiesel fuel. Ethylene propylene diene rubber (EPDM) is in addition not durable, or has poor durability, in diesel fuel.

Plastics that can break down biologically, e.g., thermoplastic starch (TPS), polylactic acid (PLA), or hard gelatins, as housing or casing materials are decomposable through bacteriological action and moisture.

Polyethylene (PE), polycarbonate (PC), and polypropylene (PP) as housing or casing materials are not durable, or have poor durability, in diesel fuel.

Polyamide (PA) as housing or casing material is attackable by organic acids, such as acetic acid; here the material layer has to be very thin in order to bring about damage to the housing or casing material through acidification, e.g., of biodiesel. In the case of aged biodiesel fuel, high temperatures above 80° C. over a longer time period, temperature peaks, and water in the contained esters lead to hydrolysis, in which the molecules are split into their original components, here the alcohol portion and the acid portion. The more the hydrolysis has progressed, the faster the further decomposition of the ester takes place, whereby the acid number, and thus the risk of negative consequences in the use of this fuel, increase exponentially. Such a degeneration of the fuel can also be detected by device 1 according to the present invention, given corresponding design of the housing or casing material of transponder 10. Organic acids also occur when water is present in oil or fuel.

The already-mentioned polycarbonate (PC) and polystyrene (PS) and polyvinyl chloride (PVC) as housing or casing materials are poorly durable, or have limited durability, in biodiesel fuel and in methyl ester.

Rubbers such as acryl nitrile butadiene rubber (NBR) as housing or casing materials become brittle due to sulfur, and thereby become susceptible to mechanical damage, or can be destroyed after becoming brittle, due to inherent tensions in the material.

Because silver reacts with sulfur to form silver sulfide, a thin silver layer, or a plastic impregnated with silver, can also be used as a housing or casing material.

Via the layer thickness of the housing or casing material, a specifiable temporally limited durability of transponder 10, modifiable in its response behavior, can be brought about.

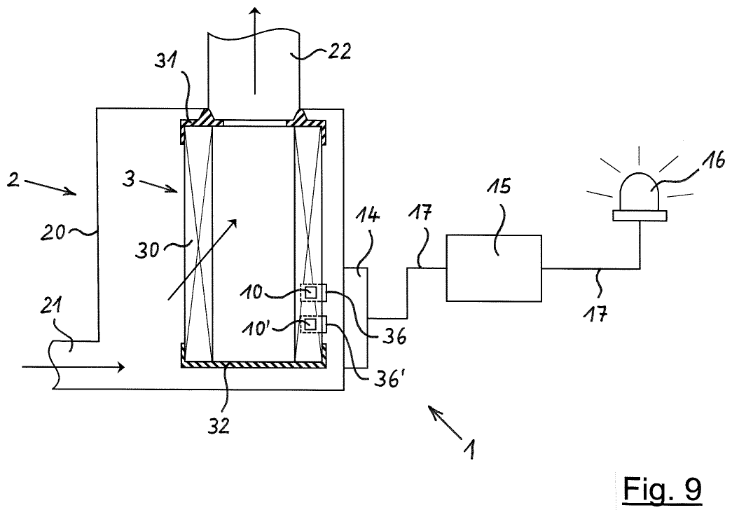

FIG. 9 shows device 1 in a schematic representation, allocated to a filter 2 shown in schematic longitudinal section, in a fourth embodiment. In the exemplary embodiment shown in FIG. 9, device 1 again has two transponders 10, 10′, attached adjacent to one another on filter material body 30 of filter cartridge 3 of filter 2, for example by gluing or welding. Here, each transponder 10, 10′ has allocated to it a rail 36, 36′, which are attached on filter material body 30 of filter cartridge 3, and that are situated in the signal transmission path between transponders 10, 10′ on one hand, and reading device 14 on the other hand Rails 36, 36′ are made of a material that is modifiable with regard to its conducting or damping properties for electromagnetic signals by influences acting during operation of filter 2. The choice of material for rails 36, 36′ is made as a function of the operating parameter or parameters to be evaluated.

In its further parts, device 1 and filter 2 according to FIG. 9 respond to the example of FIG. 1, to whose description reference is made.

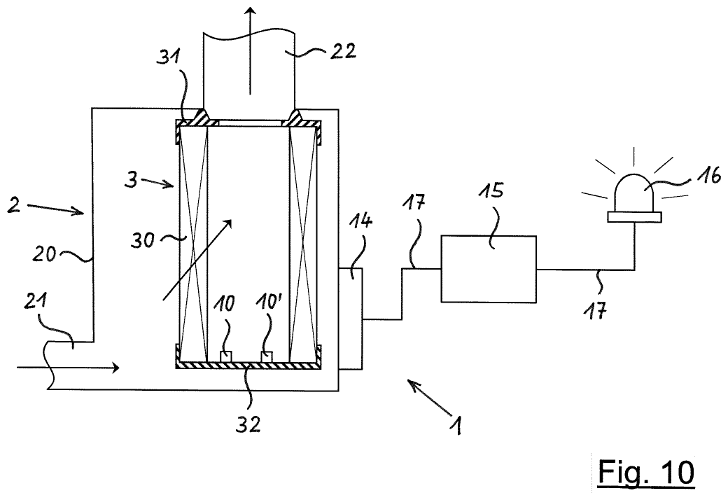

FIG. 10 shows device 1 in a schematic representation, allocated to a filter 2 shown in schematic longitudinal section, in a fifth embodiment. In this exemplary embodiment, two transponders 10, 10′ are situated on lower end plate 32 inside filter cartridge 3, for example by gluing or welding. Transponders 10, 10′ can also be molded into one or both end plates 31, 32, e.g., using the so-called in-mold method or in-mold labelings.

In its further parts and functions, device 1 and filter 2 according to FIG. 10 correspond to the example of FIG. 1, to whose description reference is made.

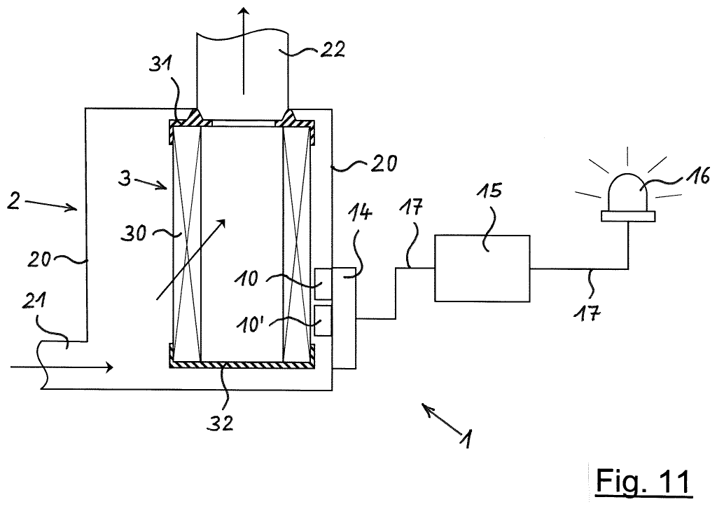

Finally, FIG. 11 shows device 1 in a schematic representation, allocated to a filter 2 shown in schematic longitudinal section, in a sixth embodiment. In this exemplary embodiment, two transponders 10, 10′ are situated on the inside of a wall of filter housing 20, radially externally from filter cartridge 3, for example by gluing or welding. In this exemplary embodiment, at least one of the transponders 10, 10′ is sensitive to influences that occur during filter operation, in order to evaluate one or more operating parameters.

Here, transponders 10, 10′ are situated opposite reading device 14 situated externally on filter housing 20, in order to obtain a short signal transmission path.

However, it is also possible here to situate transponders 10, 10′ at other locations on filter housing 20.

In principle, it is possible to provide transponders 10, 10′ at any location of filter cartridge 3 or of the interior of filter housing 20, as long as the location is exposed to the influences that act during operation, from which one or more operating parameters are evaluable.

In any case, reading device 14 is capable of detecting a modification of the response behavior of transponder 10, or of transponders 10, 10′, given influences acting on it/them, and, using evaluation unit 15, at least one operating parameter of filter 2 or filter cartridge 3 is capable of being evaluated therefrom and displayed by display unit 16.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE CHARACTERS

1 device
2 modifiable transponder
10′ non-modifiable transponder
11 RFID chip
11′ antenna
12 carrier film
13 housing or casing
13.1, 13.2 regions of 13
14 reading device
15 evaluation unit
16 display unit
17 connecting line between 14, 15, and 16
2 filter
20 filter housing
21 inlet
22 outlet
23 water collecting region
24 drainage duct
3 filter cartridge
30 filter material body
31 upper end plate
32 lower end plate
33 water droplet sieve
34 sealing mandrel
35 difference pressure sensor
36, 36′ rails

1-25. (canceled)

26. A method for determining at least one operating parameter of a filter or of a filter cartridge situated in the filter, comprising the steps:
querying at least one transponder situated on or in the filter cartridge or in a filter housing of the filter being in a contactless manner by a reading device,
analyzing a response of the transponder being analyzed in order to evaluate at least one operating parameter of the filter or filter cartridge,
exposing the transponder in the filter during its operation to influences acting on the filter cartridge,
modifying a response behavior of the transponder through an action of the influences on the transponder itself, which is sensitive to the influences, or on the conducting or damping properties of a transmission path of electromagnetic signals between the transponder and the reading device, the response behavior of the transponder being modified to a degree that is detectable by the reading device or a downstream evaluation unit and that permits a statement to be made about the at least one operating parameter of the filter or filter cartridge.

27. The method according to claim 26,
wherein the response behavior of the transponder is queried at specifiable time intervals by the reading device, and
wherein response signals of the transponder acquired by the reading device are compared with stored specified values, and
wherein evaluation is made of at least one of a presence of an original filter cartridge in the filter or the at least one operating parameter of the filter or filter cartridge.

28. A device for determining at least one operating parameter of a filter or of a filter cartridge situated in the filter, comprising:
at least one transponder being situated on or in the filter cartridge or in a filter housing of the filter, which transponder is configured to be queried in a contactless manner by a reading device, and
an evaluation unit configured to analyze a response of the transponder to evaluate the at least one operating parameter of the filter or filter cartridge,
wherein the transponder, which is exposed to influences acting on the filter cartridge in the filter during its operation and is sensitive to the influences, is configured to be modified by an action of these influences on the transponder itself or on the conducting or damping properties of a transmission path of electromagnetic signals between the transponder and reading device with regard to a response behavior of the transponder, to a degree that is detectable by the reading device or the evaluation unit and that permits a statement to be made about the at least one operating parameter of the filter or filter cartridge.

29. The device according to claim 28,
wherein a housing or casing of the transponder in the filter is configured to be attacked or destroyed by at least one of chemical, biological, physical, or mechanical attack, and
wherein the transponder as a whole, or at least a component of the transponder, is configured to be damaged or destroyed to such an extent that the response behavior of the transponder, readable by the reading device, is modifiable thereby.

30. The device according to claim 28,
wherein a housing or casing of the transponder in the filter is configured to be modifiable, by at least one of chemical, biological, physical, or mechanical action, in its conducting or damping properties for electromagnetic signals transmitted between the transponder and the reading device, and
wherein the response behavior of the transponder, acquirable by the reading device, is modifiable thereby.

31. The device according to claim 28,
wherein the transponder is situated in a region of the filter occupied in temporal succession by media that differ in their conducting or damping properties for electromagnetic signals transmitted between the transponder and the reading device, and
wherein the response behavior of the transponder, acquirable by the reading device, is modifiable thereby.

32. The device according to claim 28, wherein the transponder is configured to be sensitive to a single determined influence.

33. The device according to claim 28, wherein the transponder is configured to be sensitive to two or more different influences.

34. The device according to claim 28, wherein at least one of the transponder or the housing or casing of the transponder is configured to be temperature-sensitive in such a way that, through a one-time exceeding of a specifiable boundary temperature to which the at least one of the transponder or the housing or casing of the transponder is exposed, the response behavior of the transponder, acquirable by the reading device, is permanently modified.

35. The device according to claim 28, wherein the housing or casing of the transponder has regions made of at least two different materials that are sensitive to different influences.

36. The device according to claim 28, wherein the housing of the casing of the transponder has at least one region forming an electrical resistance path whose electrical resistance is measurable by the transponder or an electronics unit allocated to the transponder, a modification in a measured resistance causing a modification of the response behavior of the transponder that is detectable by the reading device or the evaluation unit and that permits a statement to be made about the at least one operating parameter of the filter or filter cartridge.

37. The device according to claim 28, comprising at least one of
two or more transponders, each sensitive to a single determined influence, or
two or more transponders, each sensitive to two or more different influences.

38. The device according to claim 28, comprising, in addition to the at least one transponder modifiable in its response behavior,
at least one transponder, situated on or in the filter cartridge, that is protected against or is durable against all influences acting during operation of the filter, as a permanently unmodifiable identification bearer and proof of originality of the filter cartridge.

39. The device according to claim 38, wherein in all transponders allocated to a filter or to a filter cartridge, identification codes are stored that correspond with one another and that are readable by the reading device.

40. The device according to claim 28, wherein the at least one transponder is attached on or in a filter material body of the filter cartridge or on or in at least one end plate of the filter cartridge or on or in a wall of the filter housing.

41. The device according to claim 28,
wherein the device comprises part of a fuel filter or motor oil filter or hydraulic oil filter or transmission oil filter, and
wherein the housing or casing of the transponder modifiable in its response behavior is made at least in part of a material that by at least one of fuel or oil or one or more substances contained in the fuel or in the oil, is attackable or decomposable or is modifiable in its conducting or damping properties for electromagnetic signals transmitted between the transponder and the reading device.

42. The device according to claim 28, wherein the housing or casing of the transponder modifiable in its response behavior is made at least in part of a material that through contact with at least one of microorganisms or water is attackable or decomposable or is modifiable in its conducting or damping properties for electromagnetic signals transmitted between the transponder and the reading device.

43. The device according to claim 28,
wherein the at least one transponder modifiable in its response behavior is spatially allocated to a difference pressure valve or difference pressure sensor of the filter or filter cartridge, and
wherein, by means of an element of the difference pressure valve or difference pressure sensor that is movable when there is an exceeding of a specifiable boundary value for a difference pressure existing between a raw side and clean side of the filter, the transponder configured to be mechanically damaged or destroyed, or a signal transmission property of a signal transmission path between the transponder and reading device is modifiable in such a way, that the response behavior, acquirable by the reading device of the transponder, is modifiable thereby.

44. The device according to claim 28, wherein the at least one transponder is a passive RFID transponder.

45. The device according to claim 28, wherein the at least one transponder is a semi-active or active RFID transponder having its own electrical energy source.

46. The device according to claim 45, wherein the at least one semi-active or active RFID transponder is configured for an automatic modification of items of digital response signal information that are to be outputted, the modification taking place as a function of modifications of the at least one operating parameter of the filter or filter cartridge acquired by the transponder or by at least one sensor allocated thereto.

47. The device according to claim 44, wherein the at least one passive RFID transponder is situated on a carrier foil that is at least one of bonded, glued or welded, to an inner surface of the filter housing or to the filter cartridge.

48. The device according to claim 28,
wherein the reading device is connected fixedly or detachably to the filter, or
wherein the reading device is a separate handheld mobile device.

49. A filter cartridge for use in a filter, the filter cartridge being exchangeable, wherein the filter cartridge has at least one transponder that is exposed during filter operation to influences acting on the filter cartridge, the transponder configured to be modifiable in a response behavior by the influences, as part of a device according to claim 28.

50. The filter cartridge according to claim 49, wherein, in addition to the at least one transponder modifiable in its response behavior, the filter cartridge has at least one transponder protected or durable against all influences acting during filter operation, as a permanently unmodifiable identification bearer and proof of originality of the filter cartridge.
